(19) United States
(12) Patent Application Publication
(10) Pub. No.: US 2023/0023848 A1
(43) Pub. Date: Jan. 26, 2023

(54) POLYMER-DERIVED, GRAPHENE REINFORCED CERAMIC MATRIX COMPOSITES

(71) Applicant: Agostyx LLC, Cheyenne, WY (US)

(72) Inventors: Lucas J Marin, Central Point, OR (US); Alexander Lukacs, III, Ashland, OR (US); Michael A Leimas, Central Point, OR (US)

(73) Assignee: Agostyx LLC, Cheyenne, WY (US)

(21) Appl. No.: 17/842,717

(22) Filed: Jun. 16, 2022

Related U.S. Application Data
(60) Provisional application No. 63/211,545, filed on Jun. 16, 2021.

(51) Int. Cl. C04B 41/00; C04B 35/78; C04B 35/524

(52) U.S. Cl. CPC C04B 41/0072; C04B 35/78; C04B 35/524; C04B 41/009; C04B 2235/483; C04B 2235/5292

(57) ABSTRACT

Polymer-derived, graphene reinforced ceramic matrix composites and processes for producing graphene-ceramic ceramic matrix composites are provided. An example process mechanically delaminates graphite mixed in a thermosettable, liquid preceramic polymer through a mechanical, high shear process to generate a composition of a preceramic polymer in which graphene is homogeneously dispersed. This example process does not require high temperatures and pressures to produce the graphene. The resulting composition can be pyrolytically converted to a graphene-reinforced ceramic matrix composite. A polysilazane can be used as the preceramic polymer, in some cases providing ammonia or an amine in the process to facilitate delamination of the graphite to graphene. Ceramic, metal, mineral or carbon particulates, platelets, or fibers may be added to the composition to impart enhanced mechanical and/or electrical properties to the finished graphene-reinforced ceramic matrix composites.

### RELATED APPLICATION

This application claims the benefit of priority to U.S. Provisional Patent Application No. 63/211,545 to Lukacs et al., filed Jun. 16, 2021 and incorporated herein by reference in its entirety.

### BACKGROUND

Graphene, a perfect monolayer of carbon atoms arranged into a two-dimensional honeycomb lattice, has attracted tremendous attention in recent years due to its outstanding thermal, mechanical, and electrical properties. Up to now, several methods have been used to prepare graphene particulate, such as the micromechanical cleavage of graphite, chemical reduction of exfoliated graphene oxide, and liquid phase exfoliation in water or various solvents. By far, this last technique has attracted the most attention, since it is simple, low cost, consumes little energy, and yields a high quality product.

However, one of the biggest problems with the liquid exfoliation technique has been low solvent stripping efficiency. To circumvent this problem, a number of investigators have used various additives such as sodium hydroxide and sodium citrate when aqueous media used. In the above processes, the graphene that is produced must be isolated from the materials used to effect the preparation of the graphene particulate.

### SUMMARY

Disclosed are example processes through which graphite can be mechanically delaminated through a mechanical, high shear or microwave process in a thermosettable, liquid preceramic polymer, in order to generate a composition in which graphene is homogeneously dispersed in the preceramic polymer. This composition can be pyrolytically converted to a graphene-reinforced ceramic matrix composite.

This summary is not intended to identify key or essential features of the claimed subject matter, nor is it intended to be used as an aid in limiting the scope of the claimed subject matter.

### BRIEF DESCRIPTION OF THE DRAWINGS

FIG. 1 is a diagram showing a tetrahedral structure of the ammonia molecule (symbol NH₃) in juxtaposition to a layered graphitic structure of graphite (carbon) in an example process.

FIG. 2 is a diagram showing the ammonia molecule entering between graphitic carbon layers in the graphite with assistance of nitrogen atom disruption of the interlaminar electron bonding between the graphitic carbon layers, in an example process.

FIG. 3 is a diagram of continuous mechanical shear and recycling of milled material in an example milling device in an example process.

FIG. 4 shows X-Ray diffraction analyses of example graphene dispersions.

FIG. 5 is a photograph of a cylindrical unpyrolyzed sample of a fully cured polysilazane and a similar cylindrical sample of the fully cured polysilazane that has been pyrolyzed.

FIG. 6 is a photograph of a cylindrical unpyrolyzed sample of a fully cured polysilazane and a similar, cylindrical sample of a fully cured and pyrolyzed polysilazane dispersion containing in situ generated graphene.

FIG. 7 is a photograph of a cylindrical, unpyrolyzed sample of a fully cured polysilazane containing graphene and silicon carbide, and a similar cylindrical sample of the fully cured polysilazane dispersion containing the in situ generated graphene and silicon carbide particulate after pyrolysis.

FIG. 8 is a photograph showing a dense, nonporous ceramic nature of the fully cured and pyrolyzed polysilazane dispersion containing the in situ generated graphene and silicon carbide particulate shown in FIG. 7.

FIG. 9 is a flow diagram of an example process for preparing graphene homogenously dispersed in a preceramic polymer for pyrolysis to a graphene-ceramic composite.

FIG. 10 is a flow diagram of an example process for preparing a graphene-ceramic composite.

### DETAILED DESCRIPTION

Overview

This disclosure describes polymer-derived, graphene reinforced ceramic matrix composites and processes for producing the graphene-ceramic matrix composites. The example processes include mechanical exfoliation of graphite to graphene through chemo-mechanical delamination under high shear in the presence of a thermosettable, liquid preceramic polymer. In an implementation, the preceramic polymer provides a source of ammonia, or an amine, to facilitate the delamination. The resulting dispersion or composition of graphene in preceramic polymer may be pyrolytically converted to a graphene-reinforced ceramic matrix composite material (“graphene-ceramic matrix composite”).

### Example Processes and Agents

In an example preferred process, graphite is delaminated through a mechanical, high shear process in a thermosettable, liquid preceramic polymer. A preferred preceramic polymer is a polysilazane, which has a chemical structure in which silicon and nitrogen atoms are bonded in alternating sequence to form a polymer chain. In an implementation, polysilazanes comprising nitrogen atoms bonded to hydrogen atoms are preferred. Preferred are thermosettable liquid polysilazanes containing sites of organounsaturation such as vinyl or allyl groups. Condensation of a given polysilazane under mild heating conditions results in crosslinking of the polysilazane through a transamination reaction, with release of ammonia or amine. Moreover, any adsorbed water present in the graphite can hydrolyze a small portion of the polysilazane, liberating free ammonia and aiding in the chemical exfoliation. Alternatively, the graphite can be exfoliated to graphene in the presence of the preceramic polymer through application of other energy inputs such as microwave energy.

In an implementation, polysilazanes comprising nitrogen atoms bonded to hydrogen atoms are used, in which condensation, or limited hydrolysis of the polysilazane results in generation of the ammonia. An example process described herein combines both chemically-induced graphite delamination promoted by in situ generation of ammonia, and mechanically-induced high shear.

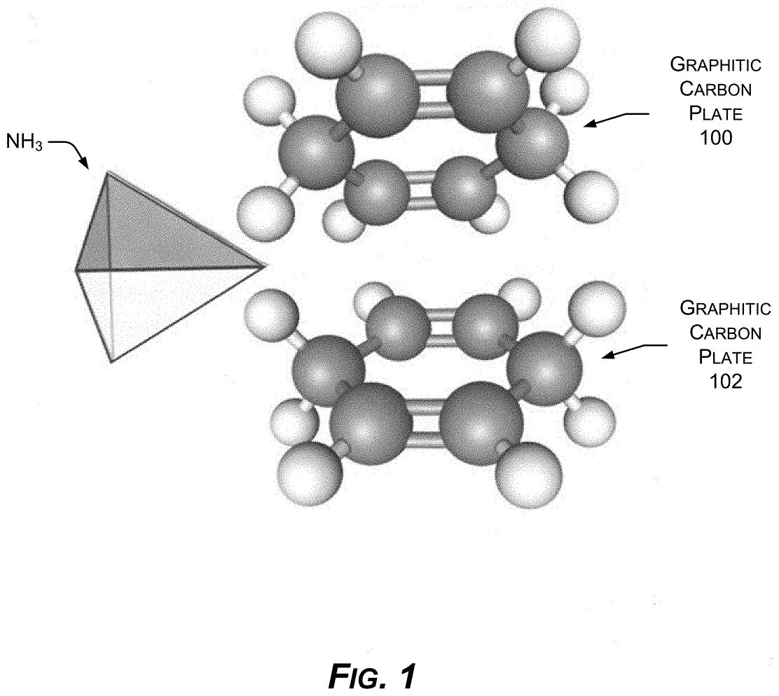

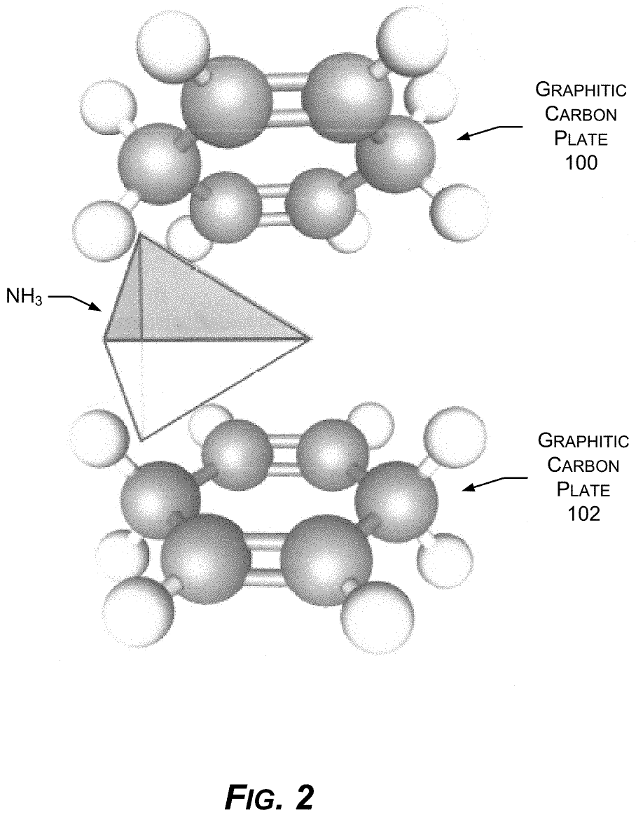

In the example process, the tetrahedral structure of the ammonia molecule as well as its electronic structure is utilized to promote the delamination of graphite. Since the diameter of ammonia is slightly greater than the interlaminar distance in graphite, the ammonia can enter the graphitic structure at one point of its tetrahedral structure in the graphite intercalation process, shown in FIG. 1. In this “wedge” mechanism of intercalation, the graphitic carbon layers 100, 102 are pried apart as the ammonia molecule enters between the graphitic carbon layers 100, 102 with the assistance of nitrogen atom disruption of the interlaminar electron bonding between the graphitic carbon layers 100, 102, as shown in FIG. 2. Since ammonia can be efficiently stripped from the system at relatively low temperatures, the solvent-stripping problem that is conventionally encountered in liquid exfoliation methods is circumvented.

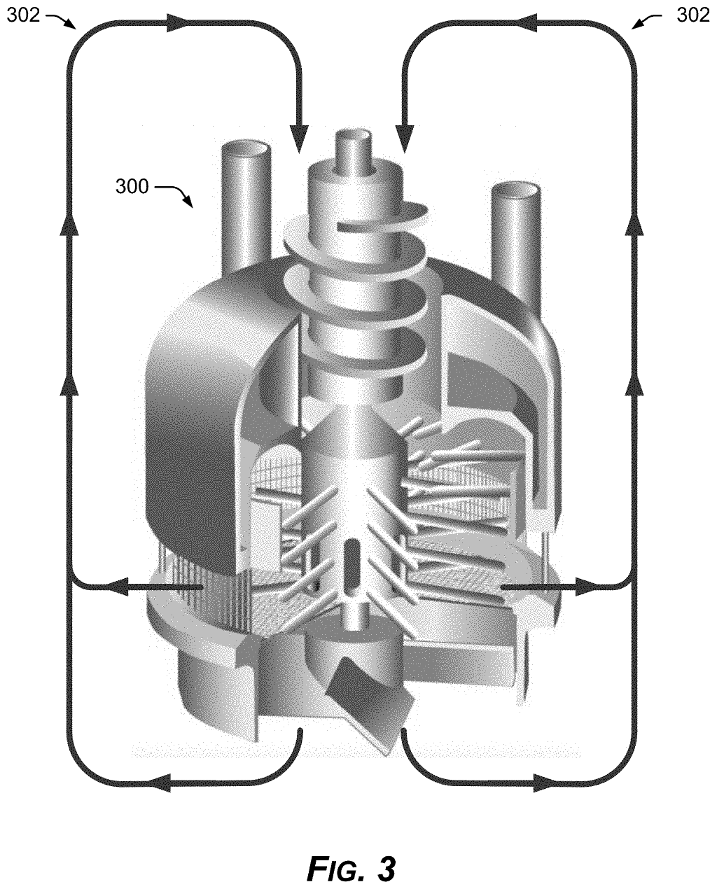

Advantageous in the example processes described herein are various milling devices, such as the milling device 300 in FIG. 3, capable of providing high mechanical shear during processing of a substance being milled. In the example milling device 300, a dispersion of graphite in a liquid preceramic polymer is repeatedly and continuously exposed to high mechanical shear energy.

“Immersion” or “basket” type mills of the type shown in FIG. 3 are preferred, and are available from Hockmeyer Equipment Corporation, for example (Hockmeyer Equipment Corp., Elizabeth City, N.C.). Immersion mills of the type shown in FIG. 3 provide a “basket” of ceramic media, for example, within a screened reservoir, in which rapidly rotating pins or “blades” (rotors and stators) provide the high shear energy useful for milling the example dispersion described herein. Hockmeyer's mills additionally utilize a rapid recirculation milling technology that continuously pumps the exit stream of the slurry or dispersion to be milled, back to the basket inlet for repeated recycling 302 and exposure to the milling process, as shown in FIG. 3. A preferred process performs such milling in the presence of an additional energy input, such as mild heating to relatively low temperatures (about 50° C. to about 100° C.). Preferred embodiments of the example process utilize high shear-efficiency “immersion” or “basket” mills such as the Hockmeyer mill described above.

Preceramic polymers are typically low molecular weight, liquid inorganic polymers that can be “thermoset” (irreversibly solidified) through the application of heat. This is advantageous in the process described herein, in that high molecular weight polymers, such as organic polymers, are typically solids that must be softened or melted in order to process them. Upon cooling they then re-solidify. Such behavior is termed “thermoplastic” This requires relatively high temperatures (often greater than 300° C.) and, even then, high pressures to induce flow due their very high viscosities at these temperatures.

Moreover, the use of thermoplastic polymers that deform during heating and pyrolysis prohibits their use when the preparation of graphene-reinforced ceramic matrix composites from a composition comprising a preceramic polymer is the desired goal. Thermosettable, liquid preceramic polymers can, by comparison, be pour-molded to a designated shape prior to their being thermoset and, then, once thermoset, can be demolded in the pre-determined shape and then pyrolyzed to a ceramic article at very high temperatures (>1,000° C.) without ever softening, melting, or otherwise deforming during the process of pyrolysis to ceramic.

Preferred embodiments of the example process to prepare in situ-generated dispersions of graphene in preceramic polymer as described herein, which utilize immersion or basket mills to effect graphite delamination to graphene do not require either elevated temperatures or elevated pressures, over ambient room temperatures and pressures.

In an example process, graphite dispersions in low molecular weight thermosettable, liquid preceramic polymers, such as DURAZANE 1800 polysilazane (Merck KGaA, Frankfurt, Germany), which is a liquid at room temperature without added solvent, and has a nominal viscosity of approximately 25-100 centipoise, can be milled directly without adding solvent and without applying elevated temperature or elevated pressure. Other polysilazanes of similar or identical composition to DURAZANE 1800 can also be used. These include CERASET Polyureasilazane, KiON Polysilazane 20, KiON HTT1800, and KiON VL20, as well as a variety of other thermosettable, liquid polysilazanes comprising sites of organounsaturation such as vinyl groups and allyl groups, although this list is not exhaustive of the many thermosettable, liquid polysilazanes that can be used in the practice of this invention.

The efficient exfoliation of 20% graphite dispersions in DURAZANE 1800 polysilazane is described below in the Production Examples provided. Using low viscosity liquid preceramic polymers additionally provides an advantage of being able to highly load the polymer with graphite without introducing a process-prohibitive high viscosity to the dispersion.

In an implementation, preceramic polymers for the example processes are thermosettable polymers having uncured room temperature viscosities of less than 10 poise, more preferably less than 1 poise, and most preferably less than 50 centipoise. Processing graphite-preceramic polymer dispersions at relatively low temperatures and low pressures is also preferred. Preferred are temperatures less than 100° C., more preferably less than 50° C., and most preferably 25° C. or below. Process pressures of less than 150 psi, more preferably less than 100 psi, and most preferably atmospheric pressure are preferred.

Example preceramic polymers suitable for the example processes and compositions described herein include polysilazanes, polysiloxanes, polysilsesquioxanes, polysilanes, polycarbosilanes, and numerous others. Additionally, other inorganic polymers can be used, such as those containing either metallic or nonmetallic elements such as aluminum and boron that can be thermally or chemically crosslinked, and converted to a ceramic material.

In order to be used to best advantage, such preceramic polymers need to be crosslinked prior to pyrolysis to provide for dimensional stability of a shaped article made from them during their conversion to ceramic material. One convenient method of crosslinking is through the application of heat. Polymers that can be crosslinked through the application of heat are called “thermosettable” polymers. This differentiates them from “thermoplastic” polymers which are solid materials that reversibly soften or melt upon the application of heat and then solidify upon cooling.

While the term “thermosettable” is used in this description, it should be understood that various catalysts such as peroxides and metal compounds can be used to reduce the temperature at which thermal crosslinking or “thermosetting” of a polymer can occur (even to room temperature as shown in the examples provided), and that such catalysts are often used to advantage to reduce the requirement to thermoset such polymers at inconveniently high temperatures. Alternative chemical crosslinking mechanisms can also be utilized to accompany the thermoset cure. Notably among these are hydrosilylation and dehydrocoupling, as well as the thermally-induced condensation polymerization that polysilazanes undergo when crosslinking to generate ammonia or even higher temperature polymer consolidation mechanisms that evolve carbon-containing gases as the polymer crosslinks to a “ceramic-like” network in the process of fully forming a ceramic at the end of a pyrolysis cycle.

The term “crosslinking” as used herein means a process that provides for the irreversible consolidation of the chemical structure of the polymer through formation of a network structure that can be converted to a ceramic through the application of energy, such as heat without dimensional deformation of the material through softening or melting.

The term “ceramic” as used herein means a refractory solid that that retains its compositional and dimensional integrity at temperatures exceeding 500° C.

The polymer-derived ceramic matrix composites of graphene described herein can be used in several electronic applications. The example processes provide facile and cost-effective methods of producing bulk preceramic polymer-derived ceramic matrix composites with high electrical conductivity, good thermal stability, and high thermal conductivity.

For this application, thermosettable liquid preceramic polymers, such as polysilazanes—polymers in which the backbone consists of alternating silicon and nitrogen atoms—are the preferred preceramic polymers. DURAZANE 1800, a liquid polysilazane that can be thermoset through heating and then converted to a ceramic, can be used to prepare a graphene-ceramic matrix composite having high electrical conductivity and enhanced thermal resistance.

In a conventional technique, graphene or graphene-ceramic matrix composites are formed through the addition of pre-formed graphene or graphene oxide powders to the preceramic polymer followed by a pyrolysis step to generate the ceramic matrix composite. The example processes described herein, on the other hand, prepare a graphene-reinforced ceramic matrix composite through an in situ generation of graphene from graphite within a thermosettable, liquid preceramic polymer followed by pyrolysis of the resulting graphene-preceramic polymer dispersion.

It is characteristic of polysilazanes that comprise nitrogen-hydrogen bonds to undergo relatively low temperature reactions in which nitrogen atoms bonded to two silicon atoms undergo thermally-induced intermolecular transamination crosslinking reactions to provide nitrogen atoms now bonded to three silicon atoms. In such reactions, the by-product is typically ammonia. Ammonia is also evolved when polysilazanes are exposed to atmospheric moisture or water, thereby incorporating oxygen into the polysilazane structure with the evolution of ammonia.

An example process described herein efficiently exfoliates graphite into graphene platelets chemo-mechanically using the ammonia or an amine evolved from a thermosettable, liquid polysilazane subjected to an energy source, such as microwave energy or mechanical shear. When a polysilazane comprising nitrogen-hydrogen bonds is used, ammonia is evolved. When a polysilazane comprising nitrogen-carbon bonds is used, an amine can be evolved.

When a polysilazane comprising nitrogen-hydrogen bonds is used, during the microwave or mechanical shear process, the ammonia that is evolved is evolved as the polysilazane experiences self-condensation. The evolved ammonia intercalates the platey graphitic structure, increasing the distance between graphene platelets in the graphite structure, and reduces the electrostatic bonding forces holding the platelets together. The microwave energy or mechanical shear energy is sufficient to cause nanoscale exfoliation of the graphite platelets to graphene.

The resulting graphene dispersion in liquid polysilazane is then thermoset and subsequently converted to a graphene-reinforced ceramic matrix composite having high electrical conductivity and enhanced thermal resistance. The graphene reinforcing phase in the resulting ceramic composite provides higher fracture toughness and flexural strength to the composite structure.

In another implementation, other discontinuous phases such as particulate ceramic or metal powders, or anisotropic fillers such as chopped carbon fiber or ceramic fiber, can also be incorporated into the resulting ceramic matrix composite simply by adding them to the polysilazane-graphite feedstock (mixture or slurry) before, while, or after processing with the microwave or mechanical shear energy. Incorporation of the discontinuous phase(s), such as the additional particulate material(s), into the compositions described herein mechanically reinforces the graphene-reinforced ceramic matrix composites after pyrolysis.

Alternatively, the particulate material, during pyrolysis, can co-react with the incipient ceramic being formed from the polysilazane to generate new high temperature phases. For example, addition of molybdenum metal powder can, in addition to assisting in graphite exfoliation, under pyrolysis conditions in the presence of polysilazane, form a pentamolybdenum trisilicide ceramic phase. Titanium metal powder can react to form titanium nitride.

Other types of particulate materials that do not react with the polysilazane during pyrolysis can also be used. Advantageous can be the use of platey, particulate materials of relatively low hardness. This includes both naturally occurring materials such as aluminosilicate minerals, and synthetically-derived materials such as low hardness refractories.

In the first class of naturally occuring materials belong such minerals as mica and talc, while in the second class of synthetically-derived materials belong such compounds as boron nitride, molybdenum disulfide, and molybdenum disilicide.

In all cases, the use of additional particulate materials such as those described above can be used to impart particularly useful characteristics to the resulting graphene-ceramic composite, such as unique electrical performance or extremely high corrosive, oxidative, or erosive resistance.

While the above description of example processes is meant to provide a broad understanding of the subject matter, the descriptions are not exclusive of other variants. A basic example process includes: 1) exfoliation of graphite to graphene in a thermosettable, liquid preceramic polymer; and 2) pyrolytic conversion of the resulting composition to a graphene-ceramic composite.

In a preferred embodiment, a polysilazane is provided as the preceramic polymer. In such embodiments the energy to effect the delamination of the graphite to graphene is provided by subjecting a composition of the polysilazane and graphite to either microwave or mechanical shear, and can be chemically assisted by intercalation of evolved ammonia or amine into the platey structure of the graphite.

This example intercalation increases the distance between adjacent graphene platelets and weakens the electrostatic forces that serve to bond adjacent platelets to one another. The ammonia is evolved from condensation reactions within the polysilazane polymer in which a more highly crosslinked and viscous composition results.

Various advantages and goals of the example processes and compositions described herein are listed below, but the list below is not intended to be comprehensive; other advantages and goals will be evident to those skilled in the art.

It is one object of this description to provide a composition comprising a thermosettable, liquid preceramic polymer and graphene wherein the graphene has been generated from graphite in the presence of the preceramic polymer through the application of an energy input.

A second object of this description is to provide a composition comprising a thermosettable, liquid preceramic polymer and graphene wherein the graphene has been generated from graphite in the presence of the preceramic polymer through the application of an energy input which is further capable of forming a graphene-ceramic composite through a pyrolysis process.

A third object of this description is to provide a composition comprising a thermosettable, liquid preceramic polymer and graphene wherein the graphene has been generated from graphite in the presence of the preceramic polymer through the application of microwave energy or a mechanical high shear process.

A fourth object of this description is to provide a composition comprising a thermosettable, liquid preceramic polymer and graphene wherein the graphene has been generated from graphite in the presence of the preceramic polymer through the application of microwave energy or a mechanical shear process which is further capable of forming a graphene-ceramic composite through a pyrolysis process.

A fifth object of this description is to provide a composition comprising a thermosettable, liquid polysilazane preceramic polymer and graphene wherein the graphene has been generated from graphite in the presence of the polysilazane through a microwave or mechanical high shear process that is chemically assisted through the intercalation of ammonia evolved from condensation of the polysilazane.

A sixth object of this description is to provide an example process to prepare a composition comprising a thermosettable, liquid preceramic polymer and graphene wherein the graphene has been generated from graphite in the presence of the preceramic polymer through a microwave or mechanical high shear process.

A seventh object of this description is to provide a process to prepare a composition comprising a thermosettable, liquid polysilazane preceramic polymer and graphene wherein the graphene has been generated from graphite in the presence of the preceramic polymer through chemically-assisted exfoliation of the graphite during a microwave or mechanical high shear process.

An eighth object of this description is to provide a process to prepare a graphene-ceramic matrix composite wherein the graphene has been generated from graphite in the presence of a thermosettable, liquid preceramic polymer through a microwave or mechanical high shear process and the graphene-ceramic matrix composite has been generated through the pyrolysis of said composition.

A ninth object of this description is to provide a graphene-ceramic matrix composite wherein the graphene in said composite has been generated from graphite in the presence of a thermosettable, liquid preceramic polymer through a microwave or mechanical high shear process and the graphene-ceramic matrix composite has been generated through the pyrolysis of said composition.

A tenth object of this description is to provide a graphene-ceramic matrix composite wherein the graphene in the composite has been generated from graphite in the presence of a thermosettable, liquid polysilazane preceramic polymer through a microwave or mechanical high shear process and the graphene-ceramic composite has been generated through the pyrolysis of the composition.

The examples set forth below serve to demonstrate specific embodiments of the subject matter, and are not meant to be exhaustive of the many variants that can be envisioned by one of skill in the art.

### Production Examples: Preparation of Graphene-Polysilazane Dispersions

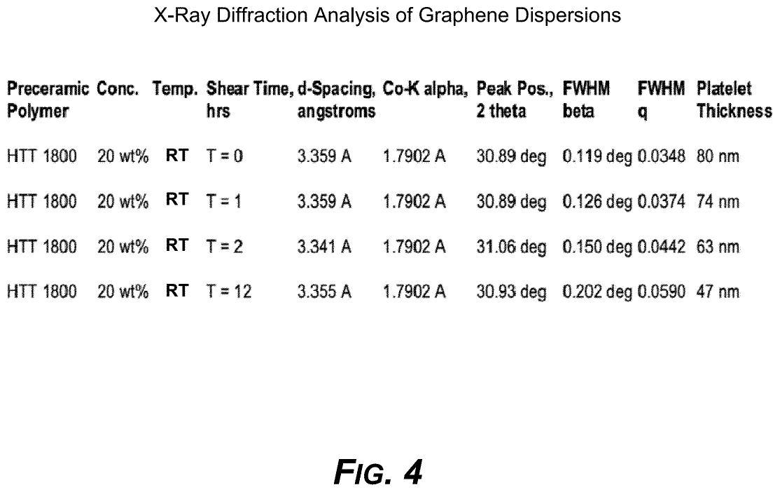

To a stainless steel 1 liter vessel was added 400 g of a thermosettable, liquid, vinyl-containing polysilazane (DURAZANE 1800, also known as KiON HTT1800 or KiON VL20). Next, 100 g of graphite flake (e.g., Asbury Graphite, natural flake, 300-500 um) was weighed and slowly added to the liquid vinyl polysilazane while stirring at room temperature. The mixture was then fixed to the vessel holding attachment of an HCP Micro Basket Mill (Hockmeyer Corporation) and the basket was filled with ˜50 ml of 2.00 mm yttria-stabilized tetragonal zirconia milling media (Glen Mills, Clifton, N.J.). A glycol chiller was attached to the vessel jacket to maintain a temperature of <85° F. during milling. The mill head was then submerged into the mixture. Prior to milling, a T=0 sample was retained in a screw-top vial. Milling was commenced and timed at 1 hour increments at 2000 rpm. At T=1, 2, and 12 hours, samples were taken and retained in screw top vials. Samples were then analyzed via X-ray diffraction (Intertek Labs, Allentown, Pa.) for d-spacing, and platelet thicknesses were calculated using the Debye-Scherrer equation. The reported data and calculated graphene platelet thicknesses of the graphene withing the resulting dispersion are shown in FIG. 4.

### Example Analytical Procedure

A few drops of the liquid dispersion produced above were placed in the recessed area of a low-background mount at room temperature (“RT”) so that the liquid surface was flush with the surrounding mount surface. The surface levels are made equal so that the peak positions are not affected by sample height. The mounted sample was scanned on a Panalytical X'Pert Pro MPD around the expected peak position range for graphite (002) using cobalt K-alpha radiation, a 0.033° step size, and a 400 sec/step count time. The graphite peak profile was fit using Panalytical HighScore+v4.8. Corrections for differences in sample height were included in the peak fitting. The Peak Positions, d-Spacing, Full Width at Half Maximum (FWHM) valueswere reported, from which the sample graphene platelet thickness could be calculated.

### Production Examples: Graphene-Reinforced Ceramic Matrix Composites (CMCs)

### First Example Procedure

Into a clean 35 ml glass test tube was added ˜30 g of DURAZANE 1800 low viscosity, thermosettable, liquid polysilazane (DURAZANE 1800 from Merck KGaA, Frankfurt, Germany). Next, ˜0.05 g of Fe(II) acetylacetonate was added directly to the liquid polysilazane and thoroughly mixed by aspiration. Finally, ˜5 g of bis-tert-amylperoxycyclohexane (LUPEROX 531 M80, 80% in mineral spirits) was added to the polysilazane and mixed thoroughly (Arkema Inc., King of Prussia, Pa.). This was repeated for a total of 4 test tubes. Two test tubes were allowed to cure at room temperature (RT) for ˜5 days, while the other two were placed in a water bath heated to ˜45° C. overnight. The results showed good through-cure with very low gas evolution and good structural integrity, with the slightly heated samples coming to a hard state sooner than the RT samples.

Cured samples were placed in ceramic racks held horizontally in a Paragon KM14 T furnace equipped with an Argon gas inlet and a programmable temperature module. The cured samples were subjected to the following pyrolysis ramp with ˜5 CFM of argon flow into the furnace during the entire program.

| Heat Cycle # | Ramp, ° F./hr | Hold temp ^{o} F. | Hold time |
|---|---|---|---|
| 1 | 1080 | RT to 850 & Hold | 4 hrs |
| 2 | 1080 | 850 to 1450 & Hold | 4 hrs |
| 3 | 1080 | 1450 to 2200 & Hold | 4 hrs |

Physical characteristics were obtained pre-pyrolysis and post-pyrolysis:

| PRE-PYROLYSIS | | POST-PYROLYSIS | |
|---|---|---|---|
| Weight prior to pyrolysis | 34.1 g | Weight post pyrolysis | 24.2 g |
| Volume prior to pyrolysis | 35.0 cm³ | Volume post pyrolysis | 16.2 cm³ |
| Density prior to pyrolysis | 0.97 g/cm³ | Density post pyrolysis | 1.5 g/cm³ |

The pyrolyzed samples of the DURAZANE 1800 polysilazane ceramic precursor were calculated to have a density of 1.5 g/cm³ demonstrating a conversion of the polysilazane polymer into a ceramic material.

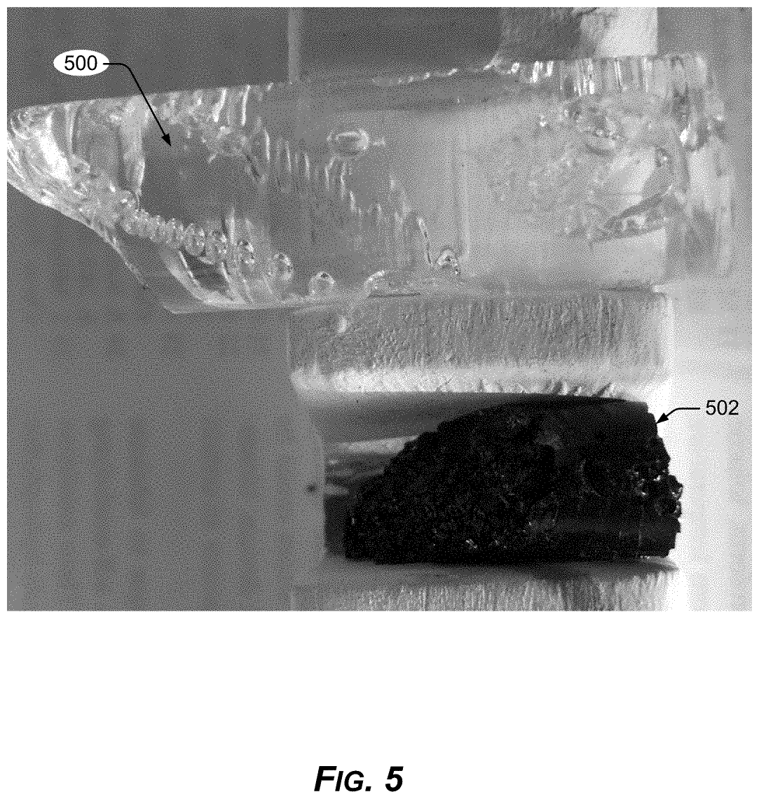

FIG. 5 shows a cylindrical, unpyrolyzed sample of the fully cured DURAZANE 1800 polysilazane 500 prepared as above by curing the liquid polysilazane in a test tube and a similar, cylindrical sample of fully cured DURAZANE 1800 polysilazane that has been pyrolyzed 502 according to the pyrolysis ramp described above. The shrinkage of the pyrolyzed DURAZANE 1800 polysilazane 502 from its original “test tube” derived dimensions and its corresponding increase in density to that of a ceramic material can be observed in FIG. 5.

### Second Example Procedure

To make an example graphene-reinforced ceramic matrix composite, about 30 g of previously exfoliated 20:80 graphite/graphene and DURAZANE 1800 polysilazane were weighed into a 35 ml glass test tube. Next, as above, ˜0.05 g of Fe(II) acetylacetonate and ˜5 g of 80% LUPEROX 531 M80 were added to the test tube and mixed thoroughly through aspiration. One sample prepared as above was allowed to cure for ˜5 days at room temperature (RT), while another was held in a water bath heated at ˜45° C. overnight. The slightly heated sample cured to a more final state with lower odor and higher integrity.

Cured samples were placed in ceramic racks held horizontally in a Paragon KM14 T furnace equipped with an argon gas inlet and a programmable temperature module. The cured samples were subjected to the following pyrolysis ramp with ˜5 CFM of argon flow into the furnace during the entire program.

| Heat Cycle # | Ramp, ° F./hr | Hold temp ° F. | Hold time |
|---|---|---|---|
| 1 | 1080 | RT to 850 & Hold | 4 hrs |
| 2 | 1080 | 850 to 1450 & Hold | 4 hrs |
| 3 | 1080 | 1450 to 2200 & Hold | 4 hrs |

Ceramic formation is shown in the weights, dimensions, and densities obtained:

| PRE-PYROLYSIS | | POST-PYROLYSIS | |
|---|---|---|---|
| Weight prior to pyrolysis | 42.1 g | Weight post pyrolysis | 36.4 g |
| Volume prior to pyrolysis | 35.0 cm³ | Volume post pyrolysis | 19.2 cm³ |
| Density prior to pyrolysis | 1.2 g/cm³ | Density post pyrolysis | 1.9 g/cm³ |

The pyrolyzed samples of the DURAZANE 1800 graphene/graphite material were calculated to have a density of 1.9 g/cm³ demonstrating a conversion of the polysilazane polymer and graphene into a ceramic material.

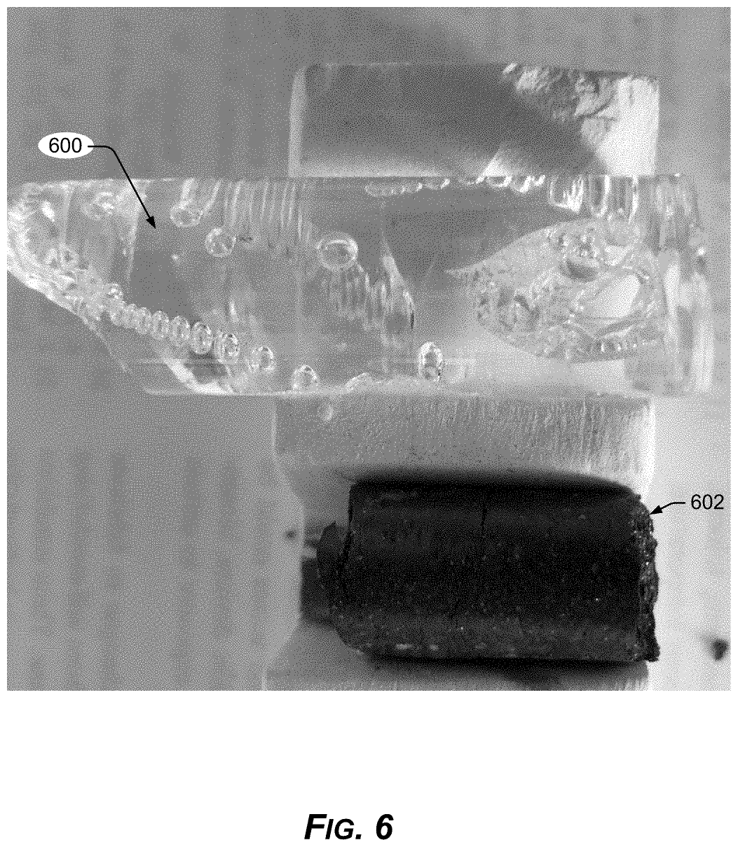

FIG. 6 shows a cylindrical, unpyrolyzed sample of the fully cured DURAZANE 1800 polysilazane 600 without graphene prepared as above by curing the liquid polysilazane in a test tube. FIG. 6 also shows a cylindrical sample of the fully cured DURAZANE 1800 polysilazane dispersion containing the 20 wt % in situ generated graphene 602 prepared as above, and pyrolyzed according to the pyrolysis ramp described above. The shrinkage of the graphene-reinforced ceramic matrix composite 602 from its original “test tube” derived dimensions and its corresponding increase in density to that of a ceramic material can be observed in FIG. 6.

### Third Example Procedure

To make another example graphene-reinforced ceramic matrix composite, 600 g of DURAZANE 1800 polysilazane was weighed into a clean stainless milling vessel, with 100 g of graphite flakes, and 100 g of 10 um silicon carbide (SiC) powder. The mixture was manually homogenized and then milled at 2500 rpm for 2.5 hours while maintaining a temperature of <85° F. The mixture was portioned out into 35 ml glass test tubes as above, cured using the Fe(II) acetylacetonate/peroxide technique as above and subjected to the same pyrolysis schedule as above.

Cured samples were placed in ceramic racks held horizontally in a Paragon KM14 T furnace equipped with an argon gas inlet and a programmable temperature module. The cured samples were subjected to the following pyrolysis ramp with ˜5 CFM of argon flow into the furnace during the entire program.

| Heat Cycle # | Ramp, ° F./hr | Hold temp ° F. | Hold time |
|---|---|---|---|
| 1 | 1080 | RT to 850 & Hold | 4 hrs |
| 2 | 1080 | 850 to 1450 & Hold | 4 hrs |
| 3 | 1080 | 1450 to 2200 & Hold | 4 hrs |

Ceramic formation is shown in the weights, dimensions, and densities obtained:

| PRE-PYROLYSIS | | POST-PYROLYSIS | |
|---|---|---|---|
| Weight prior to pyrolysis | 49.1 g | Weight post pyrolysis | 42.4 g |
| Volume prior to pyrolysis | 35.0 cm³ | Volume post pyrolysis | 18.9 cm³ |
| Density prior to pyrolysis | 1.4 g/cm³ | Density post pyrolysis | 2.2 g/cm³ |

The density of the pyrolyzed samples of the DURAZANE 1800 with graphene/graphite and SiC material was calculated at 2.2 g/cm³ demonstrating a conversion of the polysilazane polymer with graphene and SiC into a ceramic material.

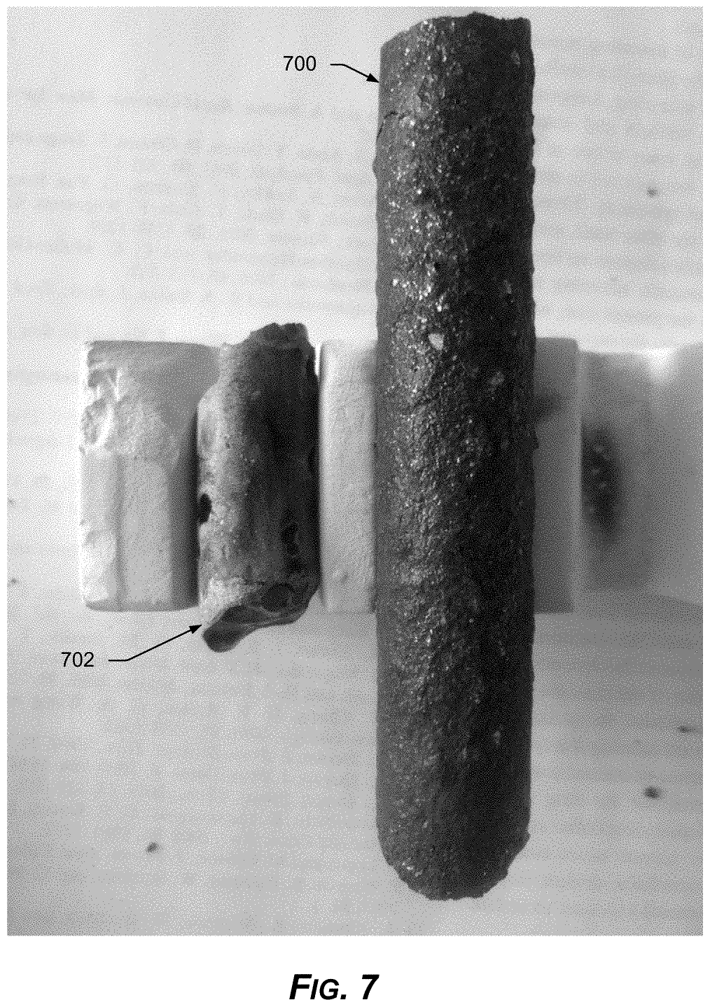

FIG. 7 shows a cylindrical, unpyrolyzed sample of the fully cured DURAZANE 1800 polysilazane with the 12.5 wt % in situ-generated graphene and 12.5 wt % added SiC, prepared by curing the liquid polysilazane mixed with graphene and SiC in a test tube. FIG. 7 also shows, a cylindrical sample of a the fully cured and pyrolyzed DURAZANE 1800 polysilazane dispersion containing the 12.5 wt % in situ generated graphene and the 12.5 wt % SiC 702 a after pyrolysis according to the pyrolysis ramp described above. The shrinkage of the pyrolyzed DURAZANE 1800 with graphene and SiC 702 from its original “test tube” derived dimensions and its corresponding increase in density to that of a ceramic material can be observed in FIG. 7.

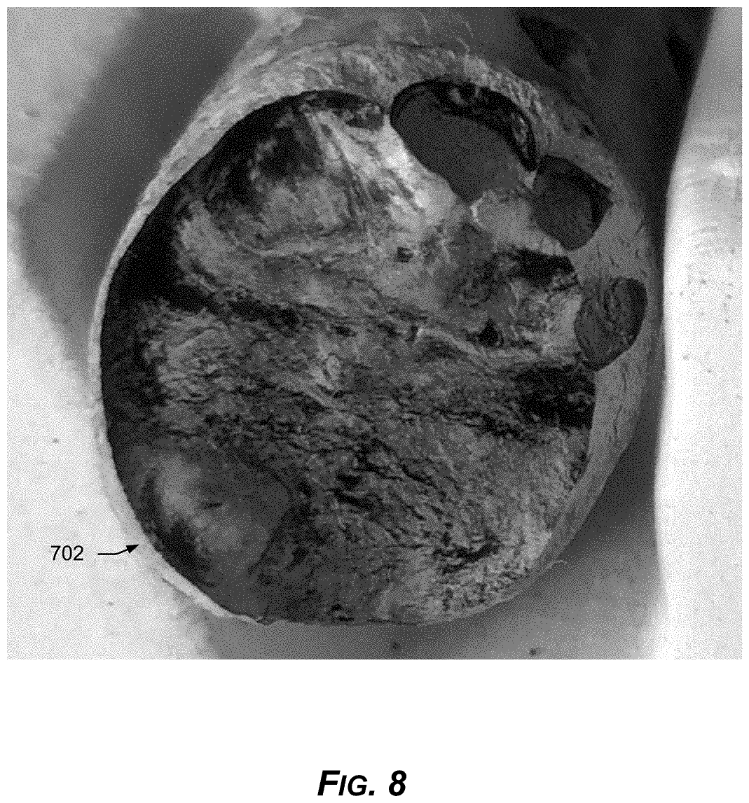

FIG. 8 shows a dense, nonporous ceramic nature of the pyrolyzed DURAZANE 1800 with graphene and SiC 702, formed in one implementation by pyrolyzing a fully cured sample of 12.5% in situ generated graphene dispersed in the DURAZANE 1800 polysilazane and further containing the silicon carbide particulate.

### Example Processes

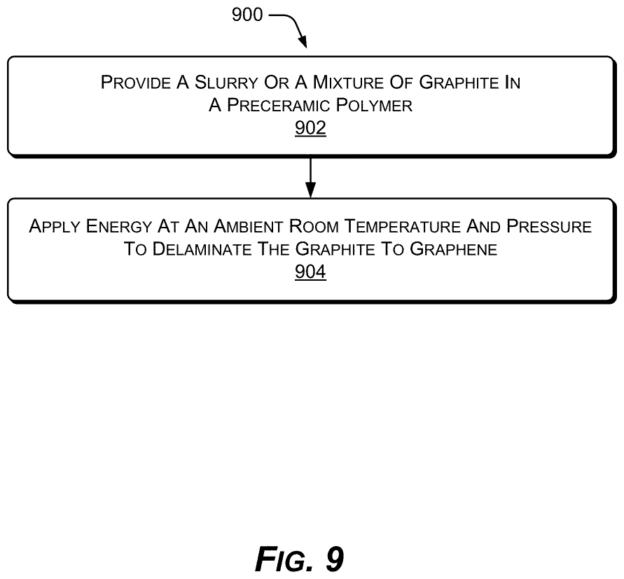

FIG. 9 shows an example process 900 for preparing graphene homogenously dispersed in a preceramic polymer, the graphene and preceramic polymer capable of being pyrolyzed to a graphene-ceramic composite.

In FIG. 9, operations of the example process 900 are shown in individual blocks.

At block 902, a slurry or mixture of graphite in a thermosettable, liquid preceramic polymer is provided.

At block 904, energy is applied at an ambient room temperature and pressure to delaminate the graphite to graphene in the slurry or mixture.

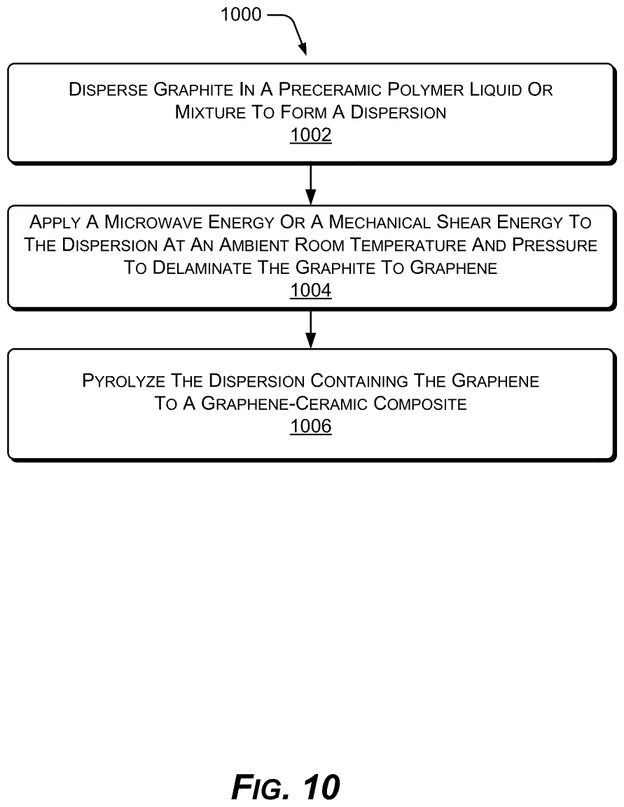

FIG. 10 shows an example process for preparing a graphene-ceramic composite. In FIG. 10, operations of the example process 1000 are shown in individual blocks.

At block 1002, graphite is dispersed in a thermosettable, liquid preceramic polymer liquid or mixture to form a dispersion

At block 1004, a microwave energy or a mechanical shear energy is applied at an ambient room temperature and pressure to the dispersion to delaminate the graphite to graphene.

At block 1006, the dispersion containing the graphene is pyrolyzed to a graphene-ceramic composite.

While the present disclosure has been disclosed with respect to a limited number of embodiments, those skilled in the art, having the benefit of this disclosure, will appreciate numerous modifications and variations possible given the description. It is intended that the appended claims cover such modifications and variations as fall within the true spirit and scope of the disclosure.

1. A process for preparing a composition for pyrolysis to a graphene-ceramic matrix composite, comprising:
providing graphite mixed in a thermosettable, liquid preceramic polymer to make a dispersion; and
providing an energy input to the dispersion to delaminate the graphite to graphene.

2. The process of claim 1, further comprising applying the energy in the form of a microwave radiation or a mechanical shear to delaminate the graphite.

3. The process of claim 1, wherein the preceramic polymer comprises a low viscosity, thermosettable, liquid preceramic polymer.

4. The process of claim 1, wherein the thermosettable, liquid preceramic polymer is a polysilazane.

5. The process of claim 4, wherein the polysilazane provides free ammonia or an amine to the dispersion during an irradiation process or a mechanical shearing process through condensation-crosslinking of the polysilazane, the free ammonia or the amine intercalating plates of the graphite to delaminate the graphite to graphene.

6. The process of claim 1, further comprising pyrolyzing the thermosettable, liquid preceramic polymer dispersion containing the graphene produced by the process to further produce a graphene-containing ceramic matrix composite.

7. The process of claim 1, further comprising providing one or more particulate materials in the dispersion selected from the group consisting of a ceramic particulate, a metal particulate, a mineral particulate, and a carbon particulate.

8. The process of claim 7, wherein the particulate material comprises a platey morphology.

9. The process of claim 7, wherein the particulate material comprises a fibrous morphology.

10. The process of claim 7, further comprising providing a particulate material reacting with the thermosettable, liquid preceramic polymer or the graphene upon pyrolysis.

11. A composition, comprising:
a continuous, thermosettable, liquid preceramic polymer component; and
a dispersed, in situ-generated graphene component.

12. The composition of claim 11, wherein the dispersed, in situ-generated graphene component comprises graphene produced from a mixture of graphite and said thermosettable, liquid preceramic polymer in the presence of a microwave energy or a mechanical milling shear energy.

13. The composition of claim 11, wherein the in situ-generated graphene and the thermosettable, liquid preceramic polymer form a graphene-reinforced ceramic matrix composite upon pyrolysis.

14. The composition of claim 11, further comprising ammonia or an amine that is formed from the condensation crosslinking of a thermosettable, liquid polysilazane preceramic polymer in the presence of the microwave energy or the mechanical milling shear energy.

15. The composition of claim 11, further comprising one or more particulate materials selected from the group consisting of a ceramic particulate, a metal particulate, a mineral particulate, and a carbon particulate.

16. The composition of claim 15, wherein the added particulate material comprises a platey morphology.

17. The composition of claim 15, wherein the added particulate material comprises a fibrous morphology.

18. A process to prepare a composition that can be pyrolyzed to a graphene-ceramic matrix composite comprising:
providing a slurry of graphite mixed in a thermosettable, liquid preceramic polymer; and
applying energy in the form of microwave radiation or a mechanical shear force to delaminate the graphite to graphene.

19. The process of claim 18, wherein the thermosettable, liquid preceramic polymer is a polysilazane.

20. The graphene-ceramic matrix composite formed by the pyrolysis of the composition formed by the process of claim 18.

21. The graphene-ceramic matrix composite formed by the pyrolysis of the composition formed by the process of claim 19.
